(19) United States
(12) Patent Application Publication
(10) Pub. No.: US 2023/0222950 A1
(43) Pub. Date: Jul. 13, 2023

(54) GAMMA CORRECTION METHOD FOR DISPLAY PANEL, GAMMA CORRECTION APPARATUS, AND DISPLAY APPARATUS

(71) Applicant: TCL CHINA STAR OPTOELECTRONICS TECHNOLOGY CO., LTD., Shenzhen (CN)

(72) Inventor: Yun Zhang, Shenzhen (CN)

(73) Assignee: TCL CHINA STAR OPTOELECTRONICS TECHNOLOGY CO., LTD., Shenzhen (CN)

(21) Appl. No.: 17/440,672

(22) PCT Filed: May 31, 2021
(86) PCT No.: PCT/CN2021/097300

§ 371 Date: Sep. 17, 2021

(30) Foreign Application Priority Data
Mar. 23, 2021 (CN) 202110306714.5

(51) Int. Cl. G09G 3/20

(52) U.S. Cl. CPC G09G 3/20; G09G 2320/0276; G09G 2320/0673; G09G 2320/0653; G09G 2310/061; G09G 2300/0861; G09G 2310/027

(57) ABSTRACT

The application provides a gamma correction method for a display panel, a gamma correction apparatus, and a display apparatus. According to whether a refresh rate of an image signal exceeds a predetermined refresh rate, choosing to use a different gamma correction curve. Therefore, when the display panel is switched from a high refresh rate to a low refresh rate, the display brightness of the display panel can be quickly adjusted, that is, the display brightness of the display panel can keep constant to avoid flicker phenomenon, and the storing space of the register is saved.

### FIELD OF THE INVENTION

The present disclosure relates to display technology field, and more particularly to a gamma correction method for display panel, a gamma correction apparatus, and a display apparatus.

### BACKGROUND

Variable refresh rate (VRR) is an important function of the display panel. VRR mode allows the display panel to switch freely between high refresh rate and low refresh rate without screen tearing. However, when some display panels switched from the high refresh rate to the low refresh frequency via VRR mode, it would cause some problems. Please refer to FIG. 1, FIG. 1 is a schematic diagram of the charging time and vertical blanking time included in each frame of the image in the prior art. As depicted in FIG. 1, when the charging time of each frame of image is the same, the frequency vertical blanking time (also called blank time) of high refresh rate is longer than that of low refresh rate. That is, the time that the picture needs to be maintained at a low refresh frequency is prolonged, which will increase the leakage time of the thin film transistor of the display panel, and reduce the brightness of the display panel. Since human eyes are more sensitive to low-brightness images than high-brightness images, flicker may be felt on the display panel at this time.

The current panel manufacturers mostly use the white balance tracking table method to improve the above problems. That is, using different white balance tracking parameters at different frequencies so that the same pixel in the display panel displays the same grayscale at different frequencies with similar brightness. Thus, the brightness of the display panel can be kept stable when the display panel is switched from a high refresh rate to a low refresh rate, and no flicker phenomenon occurs in the display panel. However, there are two problems with the white balance tracking table method. On the one hand, the white balance tracking table includes RGB grayscale parameters for each frequency. For example, an 8bit display panel needs to set 256*3=768 grayscale parameters at each frequency, and a 10-bit display panel needs to set 1024*3=3072 grayscale parameters at each frequency. Therefore, the white balance tracking parameter table requires a large storage space. On the other hand, because it is necessary to use the RGB grayscale parameters corresponding to the frequencies at each frequency, the current adjustment method has a certain delay when the high refresh rate is switched to the low refresh rate. If the frequency is switched quickly, the human eye may still feel the flicker phenomenon of the display panel.

Therefore, it is necessary to provide a method to quickly adjust the brightness of the display panel and save the storage space of the display panel when the display panel is switched from a high refresh rate to a low refresh rate, so that when the display panel is switched from a high refresh rate to a low refresh rate, the display brightness can be kept unchanged to avoid flicker phenomenon.

### SUMMARY

To solve the aforementioned problem, the embodiment of the present disclosure provides a gamma correction method for a display panel, a gamma correction apparatus, and a display apparatus.

A first objective of the embodiment of the present disclosure is to provide a gamma correction method for a display panel. The gamma correction method includes:

Receiving an image signal of front end, and detecting a refresh rate of the image signal in real time.

Performing gamma correction to the display panel with a first gamma correction curve if the refresh rate of the image signal is greater than a predetermined refresh rate.

Performing gamma correction to the display panel with a second gamma correction curve if the refresh rate of the image signal is not greater than the predetermined refresh rate.

At a same target grayscale, a target brightness corresponding to the second gamma correction curve is greater than a target brightness corresponding to the first gamma correction curve.

Preferably, in the gamma correction method for the display panel provided by the embodiment of the present disclosure, every frame of image includes a charging time and a vertical blanking time, the charging time of every frame of image is constant.

The step of receiving the image signal of front end and detecting the refresh rate of the image signal in real time further includes:

Fetching the vertical blanking time of every frame of image of the image signal in real time.

Detecting the refresh rate of the image signal in real time according to the vertical blanking time of every frame of image of the image signal.

Preferably, in the gamma correction method for the display panel provided by the embodiment of the present disclosure, the step of performing gamma correction to the display panel with the gamma correction curve further includes:

determining the target brightness corresponding to a plurality of target grayscales in the gamma correction curve, and

determining a data voltage corresponding to the target brightness and driving the display panel to display the image signal according to the data voltage.

Preferably, in the gamma correction method for the display panel provided by the embodiment of the present disclosure, at the same target grayscale, the data voltage determined corresponding to the target brightness in the second gamma correction curve is greater than the data voltage determined corresponding to the target brightness in the first gamma correction curve.

Preferably, in the gamma correction method for the display panel provided by the embodiment of the present disclosure, the target grayscale includes a plurality of characteristic binding point grayscales and binding point grayscales other than the characteristic binding point grayscales, which are obtained by interpolation according to the plurality of characteristic binding point grayscales.

Preferably, in the gamma correction method for the display panel provided by the embodiment of the present disclosure, a standard gamma value of the gamma correction is 2.2.

A second objective of the embodiment of the present disclosure is to provide a gamma correction apparatus for a display panel. The gamma correction apparatus includes:

a receiving and detecting module configured to receive an image signal of front end and detect a refresh rate of the image signal in real time,

a first gamma correction module configured to perform gamma correction to the display panel with a first gamma correction curve if the refresh rate of the image signal is greater than a predetermined refresh rate, and

a second gamma correction module configured to perform gamma correction to the display panel with a second gamma correction curve if the refresh rate of the image signal is not greater than the predetermined refresh rate.

At a same target grayscale, a target brightness corresponding to the second gamma correction curve is greater than a target brightness corresponding to the first gamma correction curve, so as to make a display brightness of the display panel under different refresh rates the same.

Preferably, in the gamma correction apparatus for the display panel provided by the embodiment of the present disclosure, every frame of image includes a charging time and a vertical blanking time. The charging time of every frame of image is constant. The receiving and detecting module is further configured to:

fetch the vertical blanking time of every frame of image of the image signal in real time, and

detect the refresh rate of the image signal in real time according to the vertical blanking time of every frame of image of the image signal.

Preferably, in the gamma correction apparatus for the display panel provided by the embodiment of the present disclosure, the first gamma correction module or the second gamma correction module is further configured to:

determine the target brightness corresponding to a plurality of target grayscales in the gamma correction curve, and

determine a data voltage corresponding to the target brightness and driving the display panel to display the image signal according to the data voltage.

Preferably, in the gamma correction apparatus for the display panel provided by the embodiment of the present disclosure, at the same target grayscale, the data voltage determined corresponding to the target brightness in the second gamma correction curve is greater than the data voltage determined corresponding to the target brightness in the first gamma correction curve.

Preferably, the gamma correction apparatus for the display panel provided by the embodiment of the present disclosure further includes an interpolation module configured to:

obtain binding point grayscales other than a plurality of characteristic binding point grayscales by interpolation according to the plurality of characteristic binding point grayscales, and

determine the plurality of characteristic binding point grayscales and the binding point grayscales other than the plurality of characteristic binding point grayscales as the target grayscale.

Preferably, in the gamma correction apparatus for the display panel provided by the embodiment of the present disclosure, a standard gamma value of the gamma correction is 2.2.

A third objective of the embodiment of the present disclosure is to provide a display apparatus. The display apparatus includes a display panel and a gamma correction apparatus for the display panel. The gamma correction apparatus includes:

a receiving and detecting module configured to receive an image signal of front end and detect a refresh rate of the image signal in real time,

a first gamma correction module configured to perform gamma correction to the display panel with a first gamma correction curve if the refresh rate of the image signal is greater than a predetermined refresh rate, and

a second gamma correction module configured to perform gamma correction to the display panel with a second gamma correction curve if the refresh rate of the image signal is not greater than the predetermined refresh rate.

At a same target grayscale, a target brightness corresponding to the second gamma correction curve is greater than a target brightness corresponding to the first gamma correction curve, so as to make a display brightness of the display panel under different refresh rates the same.

Preferably, every frame of image includes a charging time and a vertical blanking time. The charging time of every frame of image is constant. The receiving and detecting module is further configured to:

fetch the vertical blanking time of every frame of image of the image signal in real time, and

detect the refresh rate of the image signal in real time according to the vertical blanking time of every frame of image of the image signal.

Preferably, the first gamma correction module or the second gamma correction module is further configured to:

determine the target brightness corresponding to a plurality of target grayscales in the gamma correction curve, and

determine a data voltage corresponding to the target brightness and driving the display panel to display the image signal according to the data voltage.

Preferably, at the same target grayscale, the data voltage determined corresponding to the target brightness in the second gamma correction curve is greater than the data voltage determined corresponding to the target brightness in the first gamma correction curve.

Preferably, the target grayscale includes a plurality of characteristic binding point grayscales and binding point grayscales other than the characteristic binding point grayscales, which are obtained by interpolation according to the plurality of characteristic binding point grayscales.

Preferably, a standard gamma value of the gamma correction is 2.2.

A gamma correction method for a display panel, a gamma correction apparatus, and a display apparatus provided by the application receive an image signal of front end and detect a refresh rate of the image signal in real time. According to whether a refresh rate of an image signal exceeds a predetermined refresh rate, choosing to use a different gamma correction curve. Choosing the gamma correction curve with higher brightness when at a low refresh rate, so that when the leakage of the display panel is higher and the display brightness decreases at the low refresh rate, the higher brightness gamma correction curve can be used to compensate for a certain brightness. Hence, the display brightness of the display panel at a low refresh rate is the same as that at a high refresh rate. Since the amount of target grays for each gamma correction curve is less, the amount of data voltages corresponding to each set of target gray is also less.

Therefore, when the display panel is switched from a high refresh rate to a low refresh rate, the display brightness of the display panel can be quickly adjusted, that is, the display brightness of the display panel can keep constant to avoid flicker phenomenon, and the storing space of the register is saved.

### BRIEF DESCRIPTION OF THE DRAWINGS

FIG. 1 is a schematic diagram of charging time and vertical blanking time of every frame of image of existing technology.

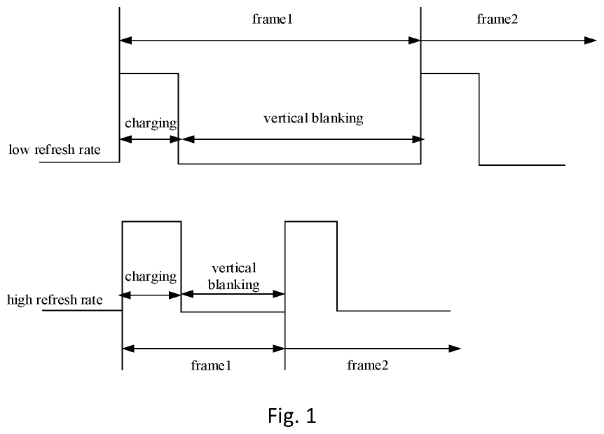

FIG. 2 is a process diagram of a gamma correction method for a display panel according to the embodiment of the present disclosure.

FIG. 3 is a schematic diagram of a first gamma correction curve and a second according to the embodiment of the present disclosure.

FIG. 4 is a structure diagram of a gamma correction apparatus for a display panel according to the embodiment of the present disclosure.

### DETAILED DESCRIPTION OF PREFERRED EMBODIMENTS

Specifically, the terminologies in the embodiments of the present disclosure are merely for describing the purpose of the certain embodiment, but not to limit the invention. Examples and the appended claims be implemented in the present disclosure requires the use of the singular form of the book “a”, “an” and “the” are intended to include most forms unless the context clearly dictates otherwise. It should also be understood that the terminology used herein that “and/or” means and includes any or all possible combinations of one or more of the associated listed items.

Gamma correction curve is also known as the grayscale-brightness curve. At present, all display panels use the same gamma correction curve at different refresh rates, so the brightness corresponding to the same grayscale in the same gamma correction curve at different refresh rates are the same. If using a same data voltage to drive the display frame image corresponding to the low refresh rate and the display frame image corresponding to the high refresh rate, the real display brightness of the display frame image corresponding to the low refresh rate is higher than the real display brightness of the display frame image corresponding to the high refresh rate.

That is, if using the same gamma correction curve at different refresh rates, the real display brightness of the display panel with the same data voltage at the low refresh rate is not enough. Therefore, the present disclosure adopts another gamma correction curve to adjust when at the low refresh rate. That is, increasing the data voltage at the low refresh rate to increase the brightness. Therefore, the real display brightness of the display panel at the low refresh rate is equal to the real display brightness of the display panel at the high refresh rate.

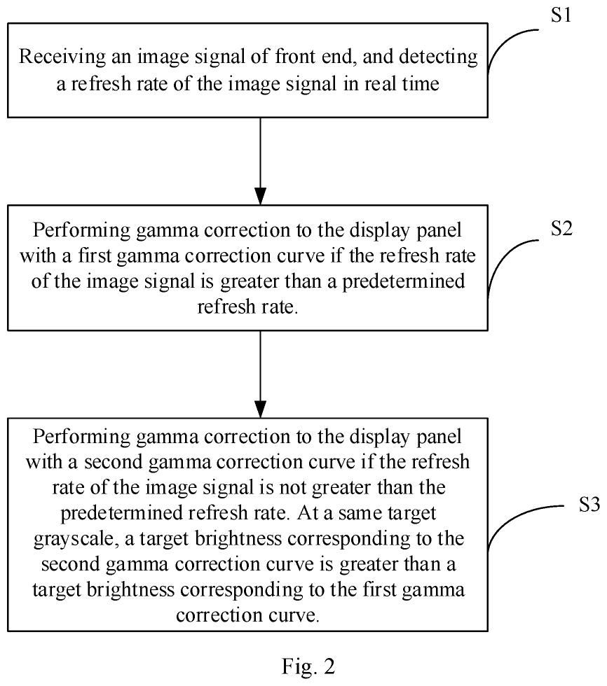

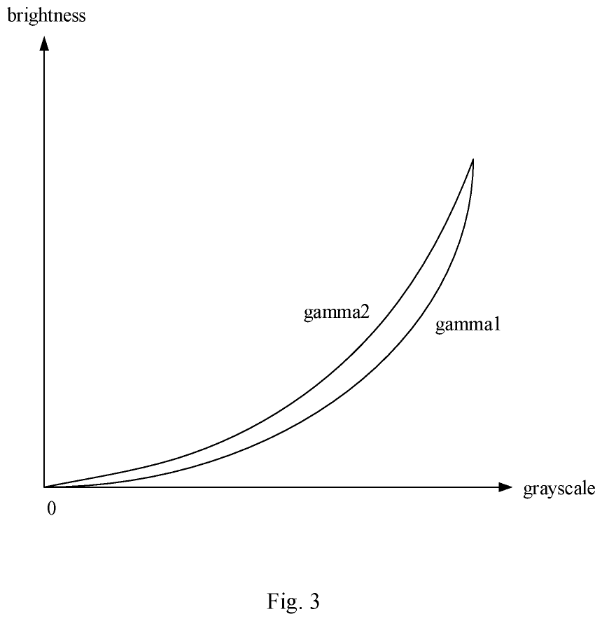

FIG. 2 is a process diagram of a gamma correction method for a display panel according to the embodiment of the present disclosure. FIG. 3 is a schematic diagram of a first gamma correction curve and a second according to the embodiment of the present disclosure. In FIG. 3, the gamma1 curve is the first gamma correction curve and the gamma2 curve is the second gamma correction curve. As depicted in FIGS. 2 and 3, the embodiment of the present disclosure provides a gamma correction method for a display panel. The method includes:

S1: Receiving an image signal of front end, and detecting a refresh rate of the image signal in real time.

S2: Performing gamma correction to the display panel with a first gamma correction curve if the refresh rate of the image signal is greater than a predetermined refresh rate.

S3: Performing gamma correction to the display panel with a second gamma correction curve if the refresh rate of the image signal is not greater than the predetermined refresh rate.

At a same target grayscale, a target brightness corresponding to the second gamma correction curve is greater than a target brightness corresponding to the first gamma correction curve.

It should be noted, the predetermined refresh rate of the embodiment of the present disclosure is a default threshold refresh rate for differentiating the high refresh rate and the low refresh rate. The refresh rate higher than the predetermined refresh rate is the high refresh rate. The refresh rate lower than the predetermined refresh rate is the low refresh rate. For example, presuming that the predetermined refresh rate is 75 Hz and the display panel supports two refresh rates of 120 Hz and 60 Hz. Then 120 Hz is the high refresh rate and using the first gamma curve to perform the gamma correction to the display panel, while 60 Hz is the low refresh rate and using the second gamma curve to perform the gamma correction to the display panel. At the same target grayscale, the target brightness corresponding to the second gamma correction curve is greater than the target brightness corresponding to the first gamma correction curve, that is, using a gamma voltage cure with higher brightness at the low refresh rate.

What needs to be explained is, that the above embodiment only set one predetermined refresh rate as the threshold refresh rate and two gamma correction curves to performing the gamma correction to the display panel is only the most basic example and applied to the case where the display panel supports two different refresh rates. When the display panel can support more than two refresh rates, setting a plurality of predetermined refresh rate as a plurality of threshold refresh rates, respectively setting gamma correction curve corresponding to every refresh rate, and performing gamma correction to the display panel with different gamma correction curves according to different refresh rates. Understandably, at the target grayscale, the target brightness corresponding to the gamma curve at the low refresh rate is greater than the target brightness corresponding to the gamma curve at the high refresh rate.

The gamma correction method for the display panel provided by the application receives an image signal of front end and detects a refresh rate of the image signal in real time. According to whether a refresh rate of an image signal exceeds a predetermined refresh rate, choosing to use a different gamma correction curve. Choosing the gamma correction curve with higher brightness when at a low refresh rate, so that when the leakage of the display panel is higher and the display brightness decreases at the low refresh rate, the higher brightness gamma correction curve can be used to compensate for a certain brightness. Hence, the display brightness of the display panel at a low refresh rate is the same as that at a high refresh rate. Since the amount of target grays for each gamma correction curve is less, the amount of data voltages corresponding to each set of target gray is also less. Therefore, when the display panel is switched from a high refresh rate to a low refresh rate, the display brightness of the display panel can be quickly adjusted, that is, the display brightness of the display panel can keep constant to avoid flicker phenomenon, and the storing space of the register is saved.

Based on the above embodiment, in the gamma correction method for the display panel provided by the embodiment of the present disclosure, every frame of image includes a charging time and a vertical blanking time, and the charging time of every frame of image is constant. The step of receiving the image signal of front end and detecting the refresh rate of the image signal in real time further includes:

fetching the vertical blanking time of every frame of image of the image signal in real time, and

detecting the refresh rate of the image signal in real time according to the vertical blanking time of every frame of image of the image signal.

It should be noted, in the existing technology, the refresh rate of the image signal is determined after image switching according to the total time of every frame (i.e., the sum of the charging time and the vertical blanking time). However, the embodiment of the present disclosure directly detects the refresh rate of the image signal in real time according to the vertical blanking time of every frame of image, which saves the determination time of the refresh rate.

For example, presuming that the display panel supports two refresh rates of 120 hz and 60 hz and the charging time of every frame of image is 2 ms. When the refresh rate is 120 hz, every frame time is 8.3 ms, the vertical blanking time is 6.3 ms. when the refresh rate is 60 hz, every frame time is 16.6 ms, the vertical blanking time is 14.6 ms. So when detecting the vertical blanking time is longer than 6.3 ms, it means that the present refresh rate is 60 hz. Therefore, it takes less time than the total time 16.6 ms of detecting every frame of image, which reduces the determination time of the refresh rate and thereby further saves the time of adjusting the display brightness of the display panel.

Based on the above embodiment, in the gamma correction method for the display panel provided by the embodiment of the present disclosure, the step of performing gamma correction to the display panel with the gamma correction curve further includes:

determining the target brightness corresponding to a plurality of target grayscales in the gamma correction curve, the smaller the target grayscale, the lower the corresponding target brightness, and

determining a data voltage corresponding to the target brightness and driving the display panel to display the image signal according to the data voltage, the lower the target brightness, the lower the corresponding data voltage.

Therefore, in the gamma correction method for the display panel provided by the embodiment of the present disclosure, at a same target grayscale, the data voltage determined corresponding to the target brightness in the second gamma correction curve is greater than the data voltage determined corresponding to the target brightness in the first gamma correction curve.

In the gamma correction method for the display panel provided by the embodiment of the present disclosure, the target grayscale includes a plurality of characteristic binding point grayscales and other binding point grayscales other than the characteristic binding point grayscales, which are obtained by interpolation according to the plurality of characteristic binding point grayscales.

It should be noted, when adjusting the gamma curve, a small amount of the characteristic binding point grayscales can be selected as the target grayscales. For example, for a display panel with 8 bits color depth (grayscale is 0 to 255), 14 characteristic binding point grayscales can be selected as the target grayscales. Each target grayscale corresponds to a data voltage, the data voltage decides the brightness of the target grayscale. And adjusting the gamma curve according to the selected target grayscale and the corresponding target brightness at the final. In addition, if more grayscales are needed to be the target grayscales, an interpolation function between the grayscales and the corresponding data voltages can be fitted according to these characteristic binding point grayscales and the corresponding data voltages. Then obtaining other binding point grayscales other than the characteristic binding point grayscales and the data corresponding to the other binding point grayscales according to the interpolation function between the corresponding data voltages and the grayscales, and determining the other binding point grayscales other than the characteristic binding point grayscales as the target grayscales.

Table 1 is the gamma voltage table of the characteristic binding point grayscales. The gamma voltage is the data voltage corresponding to the grayscale. Table 1 shows 14 characteristic binding point grayscales of ±255, ±254, ±223, ±127, ±31, ±1, and ±0 chosen from 0-255 grayscales as the target grayscales and the data voltage corresponding to these 14 characteristic binding point grayscales. The common voltage VCOM is 8.290V.

TABLE 1

| target binding point | target grayscale value | gamma voltage | |
|---|---|---|---|
| VGAM1 | 255+ | 14.49 | V |
| VGAM2 | 255− | 14.06 | V |
| VGAM3 | 254+ | 11.84 | V |
| VGAM4 | 254− | 10.71 | V |
| VGAM5 | 223+ | 10.08 | V |
| VGAM6 | 223− | 7.32 | V |
| VGAM7 | 127+ | 7.01 | V |
| VGAM8 | 127− | 6.61 | V |
| VGAM9 | 31+ | 6.26 | V |
| VGAM10 | 31− | 5.34 | V |
| VGAM11 | 1+ | 4.63 | V |
| VGAM12 | 1− | 3.44 | V |
| VGAM13 | 0+ | 0.88 | V |
| VGAM14 | 0− | 0.14 | V |

Specifically, VGAM1˜VGAM14 represents the data voltage corresponding to the 14 characteristic binding point grayscales, and the target brightness is changed by changing the 14 data voltages. Because each gamma correction curve can select only 14 characteristic binding point grayscales as the target grayscales, the data voltage corresponding to each set of the target grayscales only has 14 parameters. The amount of data is greatly reduced when compared with the white balance tracking table. Therefore, when the display panel is switched from the high refresh rate to the low refresh rate, the display brightness of the display panel can be quickly adjusted, and the storing space of the register is saved.

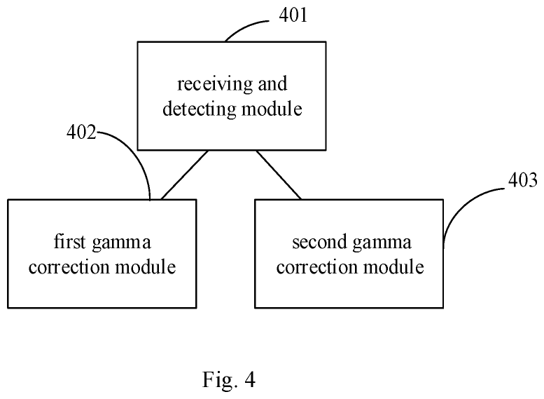

Based on the same inventive concept, FIG. 4 is a structure diagram of a gamma correction apparatus for a display panel according to the embodiment of the present disclosure. As depicted in FIG. 4, the embodiment of the present disclosure further provides a gamma correction apparatus for a display panel. The gamma correction apparatus includes:

a receiving and detecting module 401 configured to receive an image signal of front end and detect a refresh rate of the image signal in real time,

a first gamma correction module 402 configured to perform gamma correction to the display panel with a first gamma correction curve if the refresh rate of the image signal is greater than a predetermined refresh rate, and

a second gamma correction module 403 configured to perform gamma correction to the display panel with a second gamma correction curve if the refresh rate of the image signal is not greater than the predetermined refresh rate.

At a same target grayscale, a target brightness corresponding to the second gamma correction curve is greater than a target brightness corresponding to the first gamma correction curve, so as to make a display brightness of the display panel under different refresh rates the same.

The gamma correction apparatus for the display panel provided by the application receives an image signal of front end and detects a refresh rate of the image signal in real time. According to whether a refresh rate of an image signal exceeds a predetermined refresh rate, choosing to use a different gamma correction curve. Choosing the gamma correction curve with higher brightness when at a low refresh rate, so that when the leakage of the display panel is higher and the display brightness decreases at the low refresh rate, the higher brightness gamma correction curve can be used to compensate for a certain brightness. Hence, the display brightness of the display panel at a low refresh rate is the same as that at a high refresh rate. Since the amount of target grays for each gamma correction curve is less, the amount of data voltages corresponding to each set of target gray is also less. Therefore, when the display panel is switched from a high refresh rate to a low refresh rate, the display brightness of the display panel can be quickly adjusted, that is, the display brightness of the display panel can keep constant to avoid flicker phenomenon, and the storing space of the register is saved.

Based on the above embodiment, in the gamma correction apparatus for the display panel provided by the embodiment of the present disclosure, every frame of image includes a charging time and a vertical blanking time. The charging time of every frame of image is constant. The receiving and detecting module is further configured to fetch the vertical blanking time of every frame of image of the image signal in real time, and detect the refresh rate of the image signal in real time according to the vertical blanking time of every frame of image of the image signal.

Based on the above embodiment, in the gamma correction apparatus for the display panel provided by the embodiment of the present disclosure, the first gamma correction module or the second gamma correction module is further configured to:

determine the target brightness corresponding to a plurality of target grayscales in the gamma correction curve, and

determine a data voltage corresponding to the target brightness and driving the display panel to display the image signal according to the data voltage.

Based on the above embodiment, in the gamma correction apparatus for the display panel provided by the embodiment of the present disclosure, at the same target grayscale, the data voltage determined corresponding to the target brightness in the second gamma correction curve is greater than the data voltage determined corresponding to the target brightness in the first gamma correction curve.

Based on the above embodiment, the gamma correction apparatus for the display panel provided by the embodiment of the present disclosure further includes an interpolation module. The interpolation module is configured to obtain binding point grayscales other than a plurality of characteristic binding point grayscales by interpolation according to the plurality of characteristic binding point grayscales, and determine the plurality of characteristic binding point grayscales and the binding point grayscales other than the plurality of characteristic binding point grayscales as the target grayscale.

Based on the same inventive concept, the embodiment of the present disclosure further provides a display apparatus. The display apparatus includes a display panel and the gamma correction apparatus of the display panel as described above. The structure and beneficial effects of the display apparatus are the same as the gamma correction apparatus. Since the foregoing embodiments have described the gamma correction apparatus of the display panel in detail, it will not be repeated here.

The present disclosure has been described with a preferred embodiment thereof. The preferred embodiment is not intended to limit the present disclosure, and it is understood that many changes and modifications to the described embodiment can be carried out without departing from the scope and the spirit of the disclosure that is intended to be limited only by the appended claims.

What is claimed is:

1. A gamma correction method for a display panel, comprising:
receiving an image signal of front end, and detecting a refresh rate of the image signal in real time;
performing gamma correction to the display panel with a first gamma correction curve if the refresh rate of the image signal is greater than a predetermined refresh rate; and
performing gamma correction to the display panel with a second gamma correction curve if the refresh rate of the image signal is not greater than the predetermined refresh rate;
wherein at a same target grayscale, a target brightness corresponding to the second gamma correction curve is greater than a target brightness corresponding to the first gamma correction curve.

2. The gamma correction method for the display panel of claim 1, wherein every frame of image comprises a charging time and a vertical blanking time, the charging time of every frame of image is constant;
wherein the step of receiving the image signal of front end and detecting the refresh rate of the image signal in real time further comprises:
fetching the vertical blanking time of every frame of image of the image signal in real time; and
detecting the refresh rate of the image signal in real time according to the vertical blanking time of every frame of image of the image signal.

3. The gamma correction method for the display panel of claim 1, wherein the step of performing gamma correction to the display panel with the gamma correction curve further comprises:
determining the target brightness corresponding to a plurality of target grayscales in the gamma correction curve; and
determining a data voltage corresponding to the target brightness and driving the display panel to display the image signal according to the data voltage.

4. The gamma correction method for the display panel of claim 3, wherein at the same target grayscale, the data voltage determined corresponding to the target brightness in the second gamma correction curve is greater than the data voltage determined corresponding to the target brightness in the first gamma correction curve.

5. The gamma correction method for the display panel of claim 1, wherein the target grayscale comprises a plurality of characteristic binding point grayscales and binding point grayscales other than the characteristic binding point grayscales, which are obtained by interpolation according to the plurality of characteristic binding point grayscales.

6. The gamma correction method for the display panel of claim 1, wherein a standard gamma value of the gamma correction is 2.2.

7. A gamma correction apparatus for a display panel, comprising:
a receiving and detecting module, configured to receive an image signal of front end and detect a refresh rate of the image signal in real time;
a first gamma correction module, configured to perform gamma correction to the display panel with a first gamma correction curve if the refresh rate of the image signal is greater than a predetermined refresh rate; and
a second gamma correction module, configured to perform gamma correction to the display panel with a second gamma correction curve if the refresh rate of the image signal is not greater than the predetermined refresh rate;
wherein at a same target grayscale, a target brightness corresponding to the second gamma correction curve is greater than a target brightness corresponding to the first gamma correction curve, so as to make a display brightness of the display panel under different refresh rates the same.

8. The gamma correction apparatus of claim 7, wherein every frame of image comprises a charging time and a vertical blanking time, the charging time of every frame of image is constant;
the receiving and detecting module is further configured to:
fetch the vertical blanking time of every frame of image of the image signal in real time; and
detect the refresh rate of the image signal in real time according to the vertical blanking time of every frame of image of the image signal.

9. The gamma correction apparatus of claim 7, wherein the first gamma correction module or the second gamma correction module is further configured to:
determine the target brightness corresponding to a plurality of target grayscales in the gamma correction curve; and
determine a data voltage corresponding to the target brightness and driving the display panel to display the image signal according to the data voltage.

10. The gamma correction apparatus of claim 9, wherein at the same target grayscale, the data voltage determined corresponding to the target brightness in the second gamma correction curve is greater than the data voltage determined corresponding to the target brightness in the first gamma correction curve.

11. The gamma correction apparatus of claim 7, further comprising:
an interpolation module, configured to:
obtain binding point grayscales other than a plurality of characteristic binding point grayscales by interpolation according to the plurality of characteristic binding point grayscales; and
determine the plurality of characteristic binding point grayscales and the binding point grayscales other than the plurality of characteristic binding point grayscales as the target grayscale.

12. The gamma correction apparatus of claim 7, wherein a standard gamma value of the gamma correction is 2.2.

13. A display apparatus, comprising a display panel and a gamma correction apparatus for the display panel, wherein the gamma correction apparatus comprises:
a receiving and detecting module, configured to receive an image signal of front end and detect a refresh rate of the image signal in real time;
a first gamma correction module, configured to perform gamma correction to the display panel with a first gamma correction curve if the refresh rate of the image signal is greater than a predetermined refresh rate; and
a second gamma correction module, configured to perform gamma correction to the display panel with a second gamma correction curve if the refresh rate of the image signal is not greater than the predetermined refresh rate;
wherein at a same target grayscale, a target brightness corresponding to the second gamma correction curve is greater than a target brightness corresponding to the first gamma correction curve, so as to make a display brightness of the display panel under different refresh rates the same.

14. The display apparatus of claim 13, wherein every frame of image comprises a charging time and a vertical blanking time, the charging time of every frame of image is constant;
the receiving and detecting module is further configured to:
fetch the vertical blanking time of every frame of image of the image signal in real time; and
detect the refresh rate of the image signal in real time according to the vertical blanking time of every frame of image of the image signal.

15. The display apparatus of claim 13, wherein the first gamma correction module or the second gamma correction module is further configured to:
determine the target brightness corresponding to a plurality of target grayscales in the gamma correction curve; and
determine a data voltage corresponding to the target brightness and driving the display panel to display the image signal according to the data voltage.

16. The display apparatus of claim 15, wherein at the same target grayscale, the data voltage determined corresponding to the target brightness in the second gamma correction curve is greater than the data voltage determined corresponding to the target brightness in the first gamma correction curve.

17. The display apparatus of claim 13, wherein the target grayscale comprises a plurality of characteristic binding point grayscales and binding point grayscales other than the characteristic binding point grayscales, which are obtained by interpolation according to the plurality of characteristic binding point grayscales.

18. The display apparatus of claim 13, wherein a standard gamma value of the gamma correction is 2.2.
